(19) United States
(12) Patent Application Publication
(10) Pub. No.: US 2013/0203348 A1
(43) Pub. Date: Aug. 8, 2013

(54) NEAR FIELD COMMUNICATION ELECTRONIC DEVICE AND OPERATING METHOD THEREOF

(71) Applicant: Dong-Sun LIM, Seoul (KR)

(72) Inventor: Dong-Sun LIM, Seoul (KR)

(73) Assignee: SAMSUNG ELECTRONICS CO. LTD., Suwon-si (KR)

(21) Appl. No.: 13/617,110

(22) Filed: Sep. 14, 2012

(30) Foreign Application Priority Data
Feb. 2, 2012 (KR) 10-2012-0010720

(51) Int. Cl. H04B 5/00

(52) U.S. Cl. 455/41.1

(57) ABSTRACT

An electronic device and an operating method thereof are provided. The operating method thereof includes performing a first operation when the electronic device is connected with a counterpart device by a near wireless connection and performing a second operation when the electronic device is disconnected in the near wireless connection from the counterpart device.

### PRIORITY

This application claims the benefit under 35 U.S.C. §119(a) of a Korean patent application filed in the Korean Intellectual Property Office on Feb. 2, 2012 and assigned Serial No. 10-2012-0010720, the entire disclosure of which is hereby incorporated by reference.

### BACKGROUND OF THE INVENTION

1. Field of the Invention:

The present invention relates to a near wireless communication electronic device. More particularly, the present invention relates to a near wireless communication electronic device such as a Near Field Communication (NFC) electronic device and an operating method thereof

2. Description of the Related Art:

A near wireless communication method includes an NFC method, a Wireless Local Area Network (WLAN) method, a Bluetooth method, an Infrared Data Association (IrDA) method, a ZigBee method (IEEE 802.15.4), and a Home Radio Frequency method (HomeRF).

Recently, utilization of the near wireless communication method such as NFC is being enhanced. Also, for example, there is a growing tendency to mount an NFC module on a portable terminal. The NFC is one Radio Frequency Identification (RFID) technologies and corresponds to a technology for transmitting data between terminals at a short distance of 10 cm using a non-contact local area wireless communication module. The NFC method is used as a variety of application service types.

For example, if a user takes an NFC terminal near an NFC interface of a laptop computer, the laptop computer and the NFC terminal are connected through an authentication process by NFC. The user may operate the NFC terminal to control a locking or unlocking method of the laptop computer. At this time, the NFC connection between the laptop computer and the NFC terminal must be maintained. Accordingly, this locking or unlocking method is not satisfied by users in an aspect of availability.

Therefore, a need exists for an apparatus and method for an NFC electronic device for controlling an operation of a device in which it is installed according to whether it is connected with the counterpart device by NFC and an operating method thereof.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a Near Field Communication (NFC) electronic device for controlling an operation of a device in which it is installed according to whether it is connected with the counterpart device by NFC and an operating method thereof.

Another aspect of the present invention is to provide an NFC electronic device for unlocking a computer (e.g., a laptop computer, and the like) in which the NFC electronic device is installed when it is connected with a counterpart device by NFC, and locking the computer when it is disconnected from the counterpart device by NFC and an operating method thereof.

Another aspect of the present invention is to provide an NFC electronic device for verifying whether an electronic door locking and unlocking device is in a door locking state or a door unlocking state when it is connected with a counterpart device by NFC and converting a door locking state into a door unlocking state or converting the door unlocking state into the door locking state when it is disconnected from the counterpart device by NFC and an operating method thereof.

In accordance with an aspect of the present invention, an operating method of a near wireless electronic device is provided. The operating method includes performing a first operation when the near wireless electronic device is connected with a counterpart device by a near wireless connection, and performing a second operation when the near wireless electronic device is disconnected from the counterpart device by the near wireless connection.

In accordance with another aspect of the present invention, an electronic device is provided. The electronic device includes a wireless interface unit for performing a near wireless connection with a counterpart device and for transmitting and receiving signals with the counterpart device connected by a near wireless connection ,and a controller for performing a first operation when the near wireless interface unit is connected with the counterpart device by the near wireless connection and for performing a second operation when the wireless interface unit is disconnected from the counterpart device by the near wireless connection.

In accordance with another aspect of the present invention, a system for operating a near wireless electronic device is provided. The system includes the near wireless electronic device comprising a wireless interface unit for performing near wireless communications, and a controller for controlling operations of the near wireless electronic device, and a counterpart device comprising a wireless interface unit for performing wireless communications, wherein the controller of the near wireless electronic device controls the near wireless electronic device to perform at least one of a first operation and a second operation according to a status of a near wireless connection between the near wireless electronic device and the counterpart device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 is a block diagram illustrating configuration of a Near Field Communication (NFC) electronic device according to an exemplary embodiment of the present invention;

FIG. 2 is a flowchart illustrating an operating process of an NFC electronic device according to an exemplary embodiment of the present invention;

FIG. 3 illustrates an operating example of an NFC electronic device according to an exemplary embodiment of the present invention; and

FIG. 4 illustrates an operating example of an NFC electronic device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the prevent invention described hereinafter relate to an electronic device including a near wireless communication module for wirelessly communicating with a near counterpart device, and an operating method thereof The near wireless communication module may be a software module or a hardware module to provide the near wireless connection between the electronic device and the near counterpart device by a near wireless communication method.

According to exemplary embodiments of the present invention, the electronic device is, for example, one of a portable communication terminal, a portable computer, a tablet computer, a cellular phone, a mobile phone, Personal Digital Assistant (PDA) and the like.

The near wireless communication method includes a Near Field Communication (NFC) method, a Wireless Local Area Network (WLAN) method, a Bluetooth method, an Infrared Data Association (IrDA) method, a ZigBee method (IEEE 802.15.4), Home Radio Frequency method (HomeRF), and the like.

Hereunder, exemplary embodiments of the prevent invention will be described hereinafter, as an example, for an electronic device including the NFC module for controlling an operation of a device in which the NFC module is installed according to whether the device (e.g., via the NFC module) is connected with the counterpart device by the NFC method and an operating method thereof According to exemplary embodiments of the present invention, the electronic device installing the NFC module is called as an NFC electronic device.

Also, exemplary embodiments of the present invention described hereinafter relate to an NFC electronic device for unlocking a computer (e.g., a laptop computer, and the like) in which it is installed when it is connected with a counterpart device by NFC and locking the computer when it is disconnected from the counterpart device by NFC and an operating method thereof In addition, exemplary embodiments of the present invention described hereinafter relate to an NFC electronic device for verifying whether an electronic door locking and unlocking device is in a door locking state or a door unlocking state when it is connected with a counterpart device by NFC and for converting a door locking state into a door unlocking state or converting the door unlocking state into the door locking state when it is disconnected from the counterpart device by NFC and an operating method thereof.

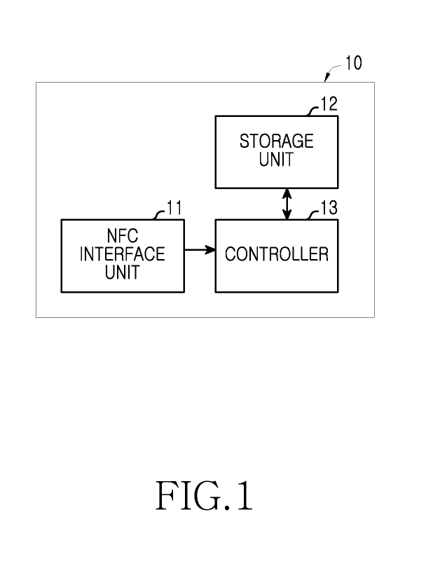

FIG. 1 is a block diagram illustrating configuration of an NFC electronic according to an exemplary embodiment of the present invention.

Referring to FIG. 1, the NFC electronic device denoted by 10 includes an NFC interface unit 11, a storage unit 12, and a controller 13. The NFC interface unit 11 performs NFC connection with a counterpart device and transmits and receives signals with the counterpart device connected by NFC. The NFC interface unit 11 has a mechanical, an electric, and a software-like configuration capable of communicating with the counterpart device. Also, the storage unit 12 stores programs for controlling an overall operation of the NFC electronic device 10, and a variety of data items input and output when a control operation of the NFC electronic device 10 is performed. In addition, the controller 13 performs a first operation when the NFC interface unit 11 is connected with the counterpart device by NFC. The controller 13 performs a second operation when the NFC interface unit 11 is disconnected from the counterpart device by NFC. The control operation of the controller 13 will be described later with reference to drawings.

The NFC electronic device 10 according to an exemplary embodiment of the present invention is mounted on a device such as, for example, a cellular phone, a PDA, a laptop computer, and the like. The NFC electronic device 10 may control operations of the device in which it is mounted.

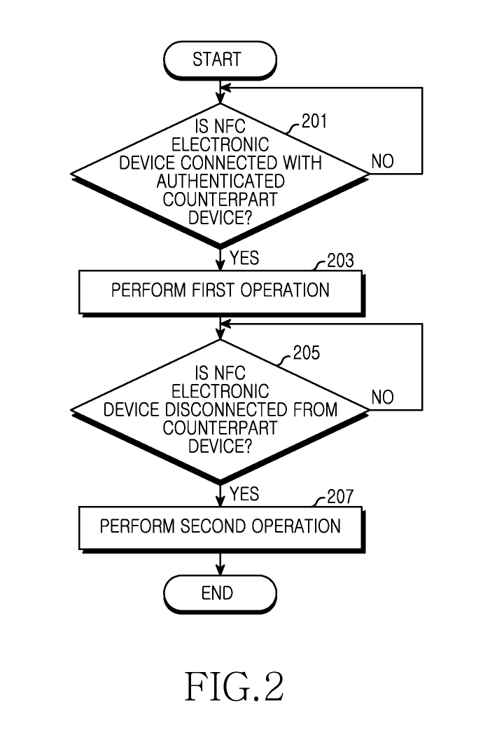

FIG. 2 is a flowchart illustrating an operation process of an NFC electronic device according to an exemplary embodiment of the present invention.

Referring to FIGS. 1 and 2, at step 201, the controller 13 determines whether the NFC electronic device is connected with a counterpart device (e.g., an authenticated counterpart device). When the controller determines that the NFC electronic device is not connected with a counterpart device, then the controller continues poll for an indication that the NFC electronic device is connected with a counterpart device. When the NFC interface unit 11 is connected with a counterpart device by NFC in step 201, the controller 13 of the NFC electronic device 10 proceeds to step 203 and performs a first operation. According to exemplary embodiments of the present invention, the NFC interface unit 11 detects a counterpart device capable of being connected with it by NFC. As an example, the controller 13 determines whether the counterpart device detected through the NFC interface unit 11 is authenticated. The controller 13 allows the NFC interface unit 11 to be connected with the authenticated counterpart device. Herein, the NFC interface unit 11 may detect the counterpart device when the counterpart device is close within signal transmission and reception distance.

At step 205, the controller determines whether the NFC interface unit 11 is disconnected from the counterpart device. When the controller determines that the NFC interface unit 11 is not disconnected from the counterpart device, the controller polls for an indication that the NFC interface unit 11 is disconnected from the counterpart device. When the NFC interface unit 11 is disconnected from the counterpart device in step 205, the controller 13 proceeds to step 207 and performs a second operation. For example, when the counterpart device connected by NFC gets out of distance in which it is impossible to transmit and receive signals with the NFC interface unit 11, the controller 13 disconnects the NFC interface unit 11 from the counterpart device.

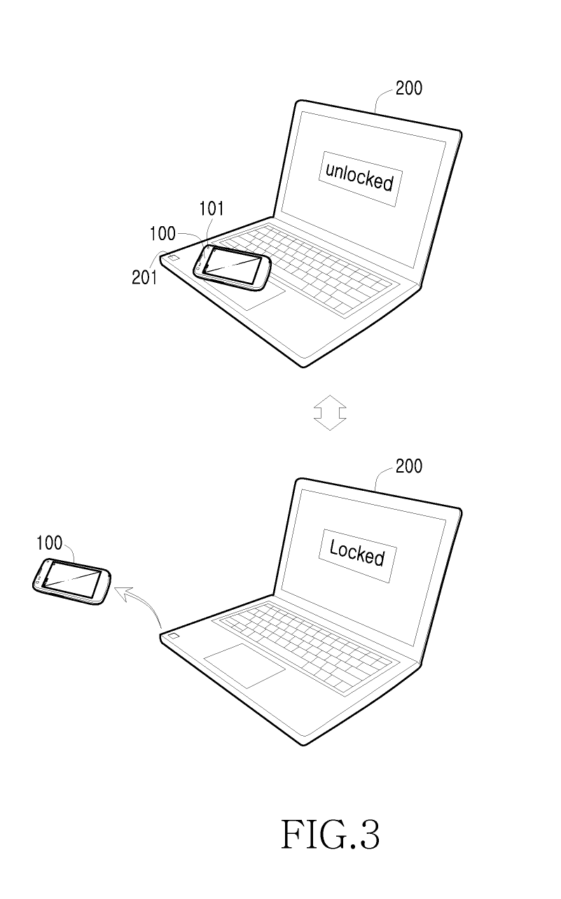

FIG. 3 illustrates an operating example of an NFC electronic device according to an exemplary embodiment of the present invention.

Referring to FIGS. 1 and 3, a laptop computer 200 mounts the NFC electronic device 10. When an NFC interface 101 of a cellular phone 100 is close to an NFC interface 201 of the NFC electronic device 10, the NFC electronic device 10 and the cellular phone 100 are connected thorough authentication by NFC. For example, the NFC electronic device 10 is connected with the cellular phone 100 by NFC, it unlocks the laptop computer 200. In addition, when the NFC electronic device 10 is disconnected from the cellular phone 100 by NFC, it locks the laptop computer 200. For example, when a user keeps the cellular phone 100 away from the laptop computer 200, the laptop computer 200 is locked so as to prevent use of the laptop computer 200 by other people.

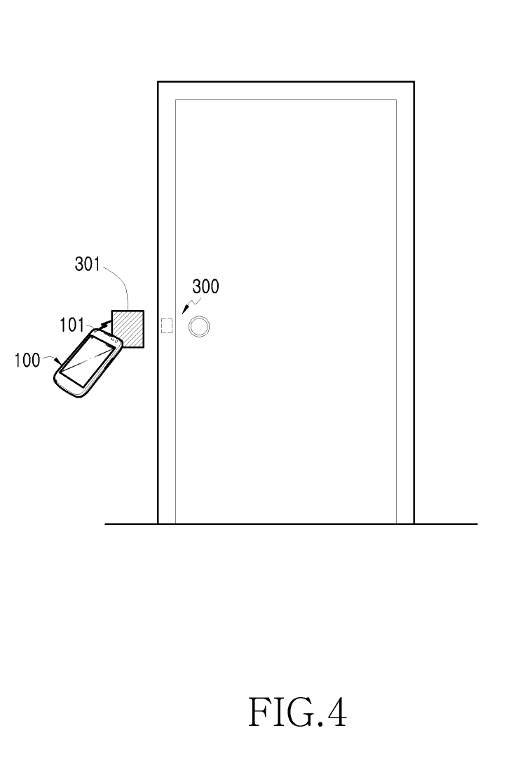

FIG. 4 illustrates an operating example of an NFC electronic device according to an exemplary embodiment of the present invention.

Referring to FIGS. 1 and 4, the NFC electronic device 10 is mounted on an electronic door locking and unlocking device 300. When an NFC interface 101 of a cellular phone 100 is close to an NFC interface 301 of the NFC electronic device 10, the NFC electronic device 10 and the cellular phone 100 are connected thorough authentication by NFC. For example, when the NFC electronic device 10 and the cellular phone 100 are connected by NFC, the NFC electronic device 10 verifies whether a door is in a door locking state or a door unlocking state. When the NFC electronic device 10 is disconnected from the cellular phone 100 by NFC, it converts a door from a door locking state to a door unlocking state or from the door unlocking state to the door locking state. That is, when a user keeps the cellular phone 100 away from the electronic door locking and unlocking device 300 after the cellular phone 100 is close to the electronic door locking and unlocking device 300, the door is unlocked or locked.

In conclusion, because the NFC electronic device according to an exemplary embodiment of the present invention performs each control operation according to whether it is connected with the counterpart device by NFC and it is disconnected from the counterpart device by NFC without holding NFC connection with the counterpart device, it is satisfied for availability by the user.

It will be appreciated that exemplary embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present invention has been shown and described with reference to exemplary embodiments thereof, it will be understood by those skilled in the art that various changes in form and details may be made therein without departing from the spirit and scope of the present invention as defined by the appended claims and their equivalents.

What is claimed is:

1. An operating method of a near wireless electronic device, the operating method comprising:
performing a first operation when the near wireless electronic device is connected with a counterpart device by a near wireless connection; and
performing a second operation when the near wireless electronic device is disconnected in the near wireless connection from the counterpart device.

2. The operating method of claim 1, wherein the near wireless electronic device controls locking and unlocking of a device in which the near wireless electronic device is installed, and
wherein the performance of the first operation when the near wireless electronic device is connected with the counterpart device by the near wireless connection comprises unlocking the device in which the near wireless electronic device is installed.

3. The operating method of claim 1, wherein the near wireless electronic device controls locking and unlocking of a device in which the near wireless electronic device is installed, and
wherein the performance of the second operation when the near wireless electronic device is disconnected from the counterpart device by the near wireless connection comprises locking the device in which it is installed.

4. The operating method of claim 1, wherein the near wireless electronic device controls locking and unlocking of a door,
wherein the performance of the first operation when the near wireless electronic device is connected with the counterpart device by near wireless comprises determining whether the door is in a door locking state or a door unlocking state, and
wherein the performance of the second operation when the near wireless electronic device is disconnected in the near wireless connection from the counterpart comprises converting the door from one of a door locking state to a door unlocking state, and the door opening state to the door locking state.

5. The operating method of claim 1, further comprising:
detecting a counterpart device capable of being connected with the near wireless electronic device by a near wireless connection;
determining whether the detected counterpart device is authenticated; and
connecting the near wireless electronic device with the authenticated counterpart device by the near wireless connection.

6. The operating method of claim 1, wherein the near wireless electronic device is a Near Field Communication device.

7. An electronic device comprising:
a wireless interface unit for performing a near wireless connection with a counterpart device and for transmitting and receiving signals with the counterpart device connected by a near wireless connection; and
a controller for performing a first operation when the near wireless interface unit is connected with the counterpart device by the near wireless connection and for performing a second operation when the near wireless interface unit is disconnected in the near wireless connection from the counterpart device.

8. The electronic device of claim 7, wherein the electronic device controls locking and unlocking of a device in which the electronic device is installed, and wherein the controller unlocks the device in which the electronic device is installed when the wireless interface unit is connected with the counterpart device by the near wireless connection.

9. The electronic device of claim 7, wherein the electronic device controls locking and unlocking of a device in which the electronic device is installed, and wherein the controller controls locking of the device in which the electronic device is installed when the wireless interface unit is disconnected in the near wireless connection from the counterpart device.

10. The electronic device of claim 7, wherein the electronic device controls locking and unlocking of a door, and
wherein the controller verifies whether the door is in a door locking state or a door unlocking state when the wireless interface unit is connected with the counterpart device by near wireless and converts the door from one of a door locking state to a door unlocking state, and the door unlocking state to the door locking state when the wireless interface unit is disconnected in the near wireless connection from the counterpart device.

11. The electronic device of claim 7, wherein the wireless interface unit detects a counterpart device capable of being connected by the near wireless connection, and
wherein the controller determines whether the counterpart device detected through the wireless interface unit is authenticated and allows the wireless interface unit to be connected with the authenticated counterpart device by the near wireless connection.

12. The electronic device of claim 6, wherein the electronic device is a Near Field Communication device.

13. A system for operating a near wireless electronic device, the system comprising:
the near wireless electronic device comprising a wireless interface unit for performing near wireless communications, and a controller for controlling operations of the near wireless electronic device; and
a counterpart device comprising a wireless interface unit for performing wireless communications,
wherein the controller of the near wireless electronic device controls the near wireless electronic device to perform at least one of a first operation and a second operation according to a status of a near wireless connection between the near wireless electronic device and the counterpart device.

14. The system of claim 13, wherein controller operatively controls the near wireless electronic device to toggle between a locked state and an unlocked state based on the status of the near wireless connection between the near wireless electronic device and the counterpart device.

15. The system of claim 14, wherein the status of the near wireless connection between the near wireless electronic device and the counterpart device is based at least in part on a proximity of the counterpart device to the near wireless electronic device.

16. The system of claim 15, wherein the wireless interface unit detects the counterpart device capable of being connected by the near wireless connection if the proximity of the counterpart device to the near wireless electronic device is less than a predefined threshold.

17. The system of claim 16, wherein if the wireless interface unit detects the counterpart device capable of being connected by the near wireless connection, then the controller of the near wireless electronic device determines whether the counterpart device detected through the wireless interface unit is authenticated and allows the wireless interface unit to be connected with the authenticated counterpart device by the near wireless connection.
